(19) United States
(12) Patent Application Publication
(10) Pub. No.: US 2012/0230451 A1
(43) Pub. Date: Sep. 13, 2012

(54) DC OFFSET ESTIMATION DEVICE AND DC OFFSET ESTIMATION METHOD

(76) Inventor: Yuan-Shuo Chang, Taoyuan County (TW)

(21) Appl. No.: 13/409,126

(22) Filed: Mar. 1, 2012

(30) Foreign Application Priority Data
Mar. 8, 2011 (TW) 100107687

(51) Int. Cl. H04L 27/06

(52) U.S. Cl. 375/340

(57) ABSTRACT

A direct current (DC) offset estimation device includes a determining circuit and an estimation circuit. The determining circuit is arranged for comparing a plurality of bits of an access code in a packet with a first predetermined value, respectively, and accordingly generating a determining result. The estimation circuit is coupled to the determining circuit, for estimating a DC offset according to the determining result.

### BACKGROUND OF THE INVENTION

1. Field of the Invention

The present disclosure relates to a DC offset estimation, and more particularly, to a DC offset device and DC offset estimation method for estimating a DC offset by comparing a plurality of bits of an access code in a packet with a first predetermined value, respectively.

2. Description of the Prior Art

Regarding a communication system, a frequency offset problem is often caused during the demodulation process of the received signals, which may result in a DC offset in the received signals. Consequently, there will be an error existed between the demodulated signals and the originally-transmitted signals.

Hence, how to quickly estimating a DC offset in order to solve the frequency offset problem has become an important topic in this field.

### SUMMARY OF THE INVENTION

It is therefore one of the objectives of the present disclosure to provide a DC offset estimation device and a DC offset estimation method to address the above-mentioned problems.

According to one aspect of the present disclosure, an exemplary DC offset estimation device is provided. The DC offset estimation device may include a determining circuit and an estimation circuit. The determining circuit is arranged for comparing a plurality of bits of an access code in a packet with a first predetermined value, respectively, and accordingly generating a determining result. The estimation circuit is coupled to the determining circuit, for estimating a DC offset according to the determining result.

According to another aspect of the present disclosure, an exemplary DC offset estimation method is provided. The method includes the following steps: comparing a plurality of bits of an access code in a packet with a first predetermined value, respectively, and accordingly generating a determining result; and estimating a DC offset according to the determining result.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a DC offset estimation device according to one embodiment of the present disclosure.

FIG. 2 is a diagram illustrating a first exemplary embodiment of a DC offset estimation device which is implemented based on the architecture shown in FIG. 1.

FIG. 3 is a diagram illustrating a second exemplary embodiment of a DC offset estimation device which is implemented based on the architecture shown in FIG. 1.

FIG. 4 is a diagram illustrating a third exemplary embodiment of a DC offset estimation device which is implemented based on the architecture shown in FIG. 1.

FIG. 5 is a flowchart illustrating a DC offset estimation method according to an exemplary embodiment of the present disclosure.

FIG. 6 is a flowchart illustrating a DC offset estimation method according to another exemplary embodiment of the present disclosure.

FIG. 7 is a flowchart illustrating a DC offset estimation method according to another exemplary embodiment of the present disclosure.

FIG. 8 is a flowchart illustrating a DC offset estimation method according to still another exemplary embodiment of the present disclosure.

### DETAILED DESCRIPTION

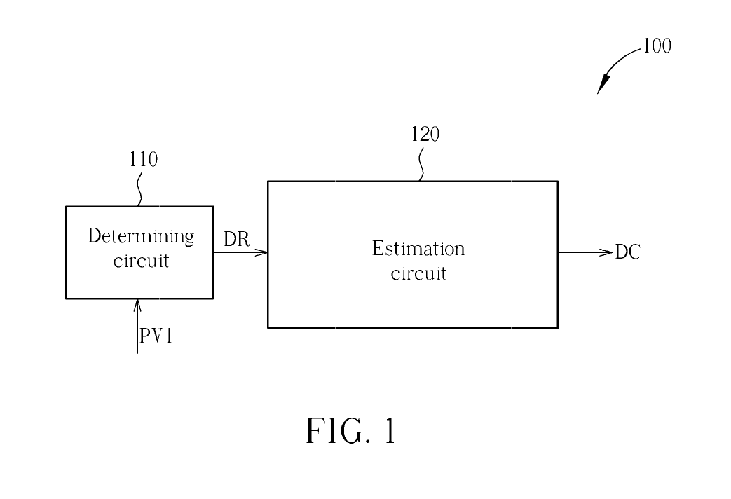

Please refer to FIG. 1. FIG. 1 is a diagram of a direct current (DC) offset estimation device according to one embodiment of the present disclosure. As shown in FIG. 1, the DC offset estimation device 100 may include a determining circuit 110 and an estimation circuit 120. The determining circuit 110 is arranged for comparing a plurality of bits of an access code in a packet with a first predetermined value PV1, respectively, and accordingly generating a determining result DR. In addition, the estimation circuit 120 is coupled to the determining circuit 110, for estimating a DC offset DC according to the determining result DR. Please note that: the plurality of bits of the access code mentioned in the present disclosure may be a demodulated voltages level of the access code being demodulated by a demodulator (not shown in FIG. 1). However, this is presented merely to illustrate a practicable design of the present disclosure, and in no way should be considered to be limitations of the scope of the present disclosure. For example, the original access code may contain bits of “0” or “1”. After the access code is demodulated by the demodulator, the bit “0” of the access code should be corresponding to a first voltage level (such as, −1) and the bit “1” of the access code should be corresponding to a second voltage level (such as, 1). In other words, assume that there is no DC offset problem, the plurality of bits of the access code will be either “1” or “−1”, which can be readily understood by those skilled in the art, and further description is omitted here for brevity.

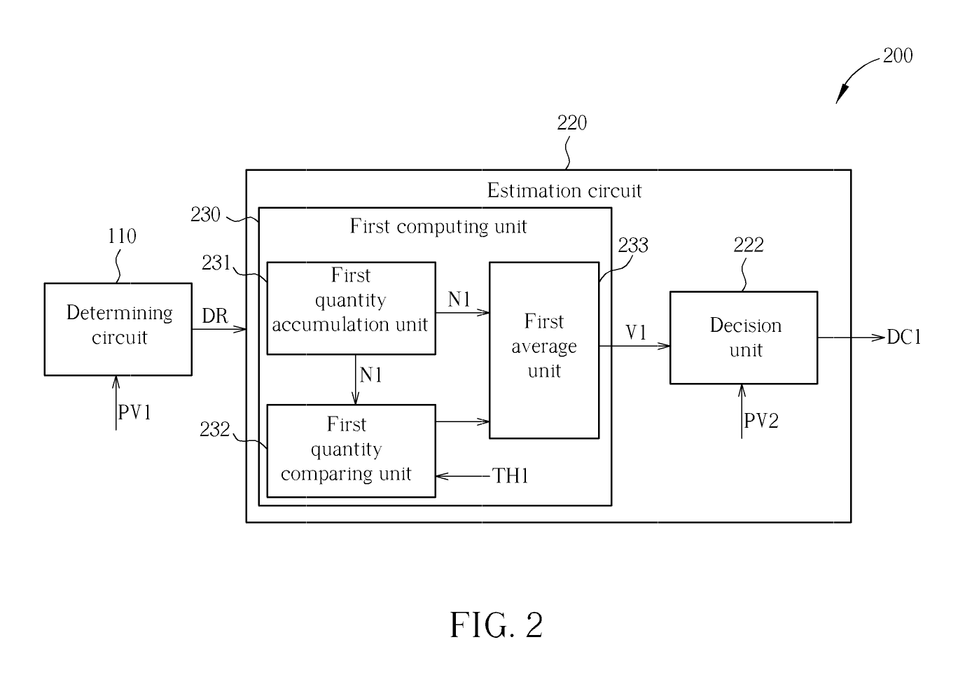

Please refer to FIG. 2. FIG. 2 is a diagram illustrating a first exemplary embodiment of a DC offset estimation device which is implemented based on the architecture shown in FIG. 1. The major difference between the DC offset estimation device 200 shown in FIG. 2 and the DC offset estimation device 100 shown in FIG. 1 is the estimation circuit 220. In this embodiment, the estimation circuit 220 may include a first computing unit 230 and a decision unit 222. The first computing unit 230 is coupled to the determining circuit 110, for generating a first average value V1 according to a value and a quantity of the bits of the access code which is greater than the first predetermined value PV1 by using the determining result DR. The decision unit 222 is coupled to the first computing unit 230, for estimating the DC offset DC1 according to at least the first average value V1. Please note that: in this embodiment, the first predetermined value PV1 may be “0”. However, this is presented merely for illustrating the present disclosure, and should not be considered as a limitation of the present disclosure.

Please keep referring to FIG. 2. The first computing unit 230 may include a first quantity accumulation unit 231, a first quantity comparing unit 232, and a first average unit 233. The first quantity accumulation unit 231 is arranged for accumulating the quantity of the bits of the access code which is greater than the first predetermined value PV1 by using the determining result DR, and accordingly generating a first quantity accumulated value N1. The first quantity comparing unit 232 is arranged for comparing the first quantity accumulated value N1 with a first threshold TH1. The first average unit 233 is arranged for calculating the first average value V1 when the first quantity accumulated value N1 is greater than the first threshold TH1. After that, the decision unit 222 may estimate the DC offset DC1 according to a difference between the first average value V1 and a second predetermined value PV2.

For example, in this embodiment, the determining circuit 110 may compare a plurality of bits of the access code in the packet with a first predetermined value PV1 (such as, 0), respectively, in order to determine whether the bits are greater than the first predetermined value PV1, and accordingly generate the determining result DR. After that, the first quantity accumulation unit 231 may accumulate the quantity of the bits of the access code which is greater than 0 by using the determining result DR, and accordingly generate the first quantity accumulated value N1. In other words, the first quantity accumulated value N1 is equal to the accumulated quantity of the bits of the access code which belong to a positive number. If the first threshold is set as 20, the first average unit 233 starts to calculate the first average value V1 when the first quantity accumulated value N1 is greater than 20. The first average value V1 is equal to the result obtained from dividing a sum of positive numbers of the plurality of bits of the access code by the first quantity accumulated value N1. After that, the decision unit 222 may determine the DC offset DC1 according to a difference between the first average value V1 and a second predetermined value (such as, 1). For example, if the first average value V1 calculated by the first average unit 233 is equal to 1.2, then the DC offset DC1 is equal to 0.2.

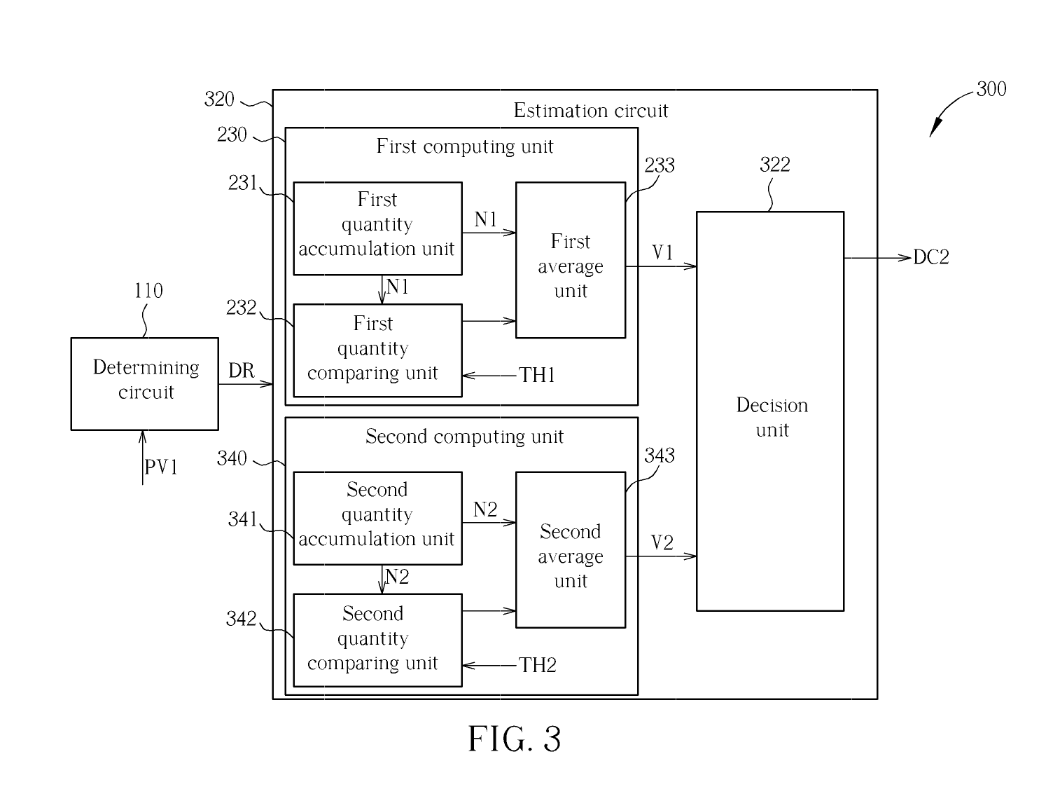

Please refer to FIG. 3. FIG. 3 is a diagram illustrating a second exemplary embodiment of a DC offset estimation device which is implemented based on the architecture shown in FIG. 1. Since the architecture of the DC offset estimation device 300 shown in FIG. 3 is similar to that of the DC offset estimation device 200 shown in FIG. 2, the operations of the determining circuit 110 and the first computing unit 230 are omitted here for brevity. Besides, the difference between the DC offset estimation device 300 and the DC offset estimation device 200 is that: an estimation circuit 320 of the DC offset estimation device 300 further includes a second computing unit 340. The second computing unit 340 is coupled to the determining circuit 110 and the decision unit 322, for generating a second average value V2 according to a value and a quantity of the bits of the access code which is smaller than the first predetermined value PV1 by using the determining result DR. By comparing the decision unit 322 shown in FIG. 3 with the decision unit 222 shown in FIG. 2, the decision unit 322 may estimate the DC offset DC2 according to the first average value V1 and the second average value V2.

The second computing unit 340 may include a second quantity accumulation unit 341, a second quantity comparing unit 342, and a second average unit 343. The second quantity accumulation unit 341 is arranged for accumulating the quantity of the bits of the access code which is smaller than the first predetermined value PV1 by using the determining result DR, and accordingly generating a second quantity accumulated value N2. The second quantity comparing unit 342 is arranged for comparing the second quantity accumulated value N2 with a second threshold TH2. The second average unit 343 is arranged for calculating the second average value V2 when the second quantity accumulated value N2 is greater than the second threshold TH2. Please note that: in this embodiment, the decision unit 320 may determine the DC offset DC2 according to the first average value V1 and the second average value V2. However, this is presented merely for illustrating the present disclosure, and should not be considered as a limitation of the present disclosure.

For example, in this embodiment, the second quantity accumulation unit 341 may accumulate the quantity of the bits of the access code which is smaller than 0 by using the determining result DR, and accordingly generate the second quantity accumulated value N2. In other words, the second quantity accumulated value N2 is equal to the accumulated quantity of the bits of the access code which belong to a negative number. If the second threshold TH2 is set as 10, the second average unit 343 starts to calculate the second average value V2 when the second quantity accumulated value N2 is greater than 10. In other words, the second average value V2 is equal to the result obtained from dividing a sum of negative numbers of the plurality of bits of the access code by the second quantity accumulated value N2. After that, the decision unit 320 may determine the DC offset DC2 according to a mean of the first average value V1 and the second average value V2. For example, if the first average value V1 calculated by the first average unit 233 is equal to 1.2 and the second average value V2 calculated by the second average unit 343 is equal to −0.8, then the DC offset DC2 is equal to 0.2.

Please note that: in this embodiment, by setting the first threshold TH1 and the second threshold TH2, the DC offset can be quickly estimated before all bits of the access code are completely received.

Please keep referring to FIG. 3. In another embodiment of the present disclosure, the first quantity comparing unit 232, the second quantity comparing unit 342, the first threshold TH1, and the second threshold TH2 are not required. Instead, the determining circuit 110 may compare a plurality of bits (such as, 64 bits) of a complete access code in a packet with a first predetermined value PV1 (such as, 0), respectively, and accordingly generating a determining result DR. The first quantity accumulation unit 231 may accumulate the quantity of the bits of the complete access code which is greater than 0 by using the determining result DR, and accordingly generate a first quantity accumulated value N1. That is, the first average value V1 is equal to the result obtained from dividing a sum of positive numbers of the plurality of bits of the complete access code by the first quantity accumulated value N1. The second quantity accumulation unit 341 may accumulate the quantity of the bits of the complete access code which is smaller than 0 by using the determining result DR, and accordingly generate a second quantity accumulated value N2. That is, the second average value V2 is equal to the result obtained from dividing a sum of negative numbers of the plurality of bits of the access code by the second quantity accumulated value N2. After that, the decision unit 320 may determine the DC offset DC2 according to a mean of the first average value V1 and the second average value V2.

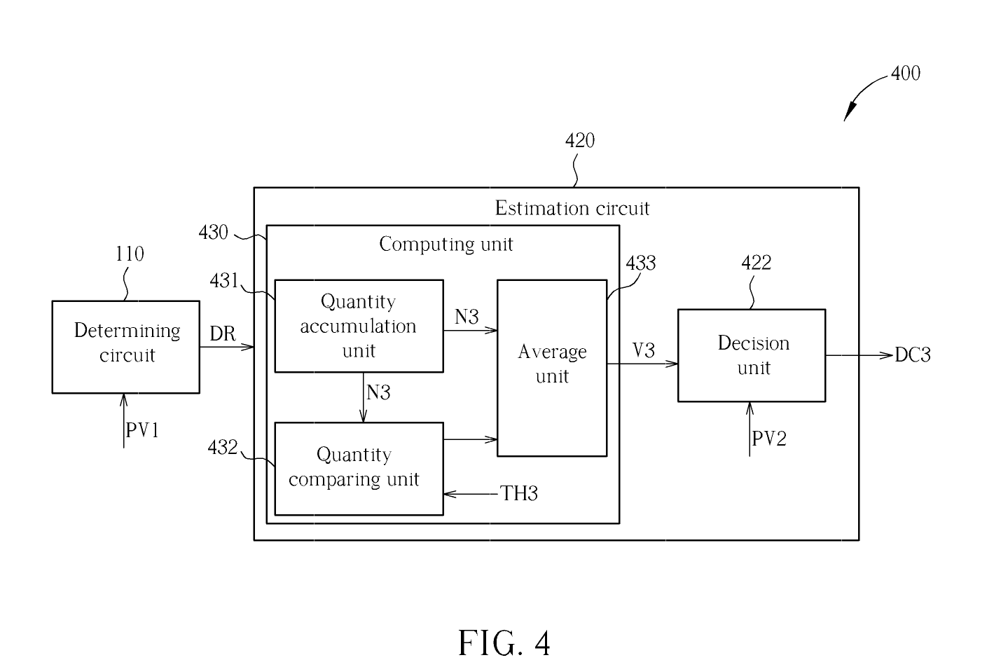

Please refer to FIG. 4. Please refer to FIG. 4. FIG. 4 is a diagram illustrating a third exemplary embodiment of a DC offset estimation device which is implemented based on the architecture shown in FIG. 1. The architecture of the DC offset estimation device 400 shown in FIG. 4 is similar to that of the DC offset estimation device 200 shown in FIG. 2, and the major difference between them is that: the first average value V1 is a mean of the plurality of bits of the access code belonging to a positive number, but the average value V3 is a mean of the plurality of bits of the access code belonging to a negative number.

The estimation circuit 420 may include a computing unit 430 and a decision unit 422. The computing unit 430 is coupled to the determining circuit 110, for generating an average value V3 according to a value and a quantity of the bits of the access code which is smaller than the first predetermined value PV1 by using the determining result DR. The decision unit 422 is coupled to the computing unit 430, for estimating the DC offset DC3 according to the average value V3. The computing unit 430 may include a quantity accumulation unit 431, a quantity comparing unit 432, and an average unit 433. The quantity accumulation unit 431 is arranged for accumulating the quantity of the bits of the access code which is smaller than the first predetermined value PV1, and accordingly generate a quantity accumulated value N3. The quantity comparing unit 432 is arranged for comparing the quantity accumulated value N3 with a threshold TH3. The average unit 433 is arranged for calculating the average value V3 when the quantity accumulated value N3 is greater than the threshold TH3. After that, the decision unit 422 may determine the DC offset DC3 according to a difference between the average V3 and a predetermined value PV2 (such as, −1). For example, if the average value V3 calculated by the average unit 433 is equal to −0.7, then the DC offset DC3 is equal to 0.3.

Please note that: those skilled in the art can readily understand the operations of the computing unit 430 and the decision unit 422 of the estimation circuit 420 shown in FIG. 4 by reference to the technical features of the first computing unit 230 shown in FIG. 2 and the decision unit 322 shown in FIG. 3, and detailed description of the estimation circuit 420 is omitted here for brevity.

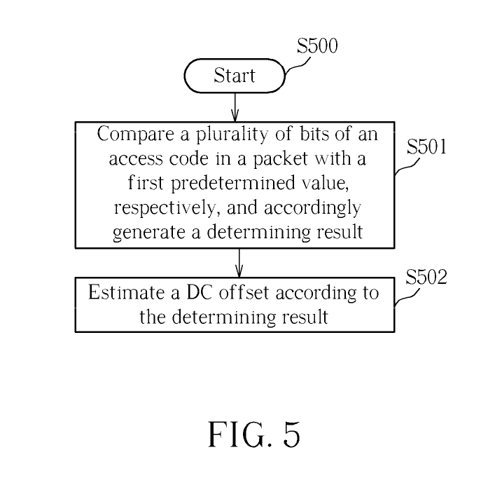

Please refer to FIG. 5. FIG. 5 is a flowchart illustrating a DC offset estimation method according to an exemplary embodiment of the present disclosure.

Step S500: Start.

Step S501: Compare a plurality of bits of an access code in a packet with a first predetermined value, respectively, and accordingly generate a determining result.

Step S502: Estimate a DC offset according to the determining result.

Those skilled in the art can readily understand how each element operates by combining the steps shown in FIG. 5 and the elements shown in FIG. 1, and further description is omitted here for brevity. The step S501 is executed by the determining circuit 110, and the step S502 is executed by the estimation circuit 120.

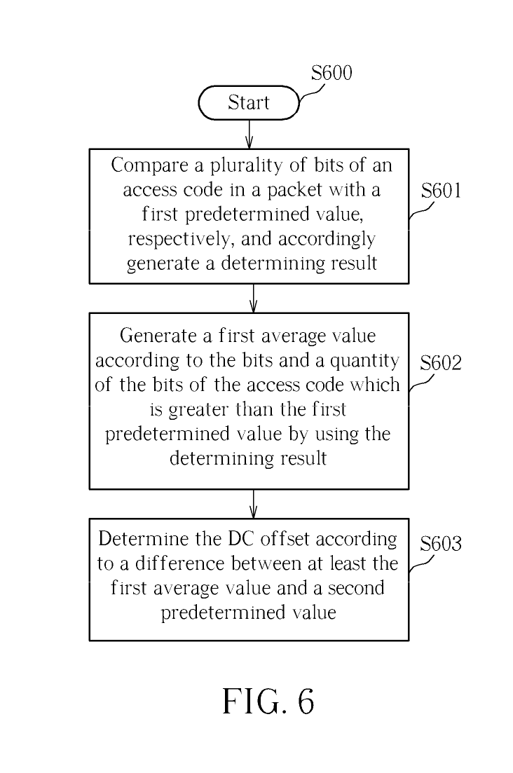

Please refer to FIG. 6. FIG. 6 is a flowchart illustrating a DC offset estimation method according to another exemplary embodiment of the present disclosure.

Step S600: Start.

Step S601: Compare a plurality of bits of an access code in a packet with a first predetermined value, respectively, and accordingly generate a determining result.

Step S602: Generate a first average value according to a value and a quantity of the bits of the access code which is greater than the first predetermined value by using the determining result.

Step S603: Determine the DC offset according to a difference between at least the first average value and a second predetermined value.

Those skilled in the art can readily understand how each element operates by combining the steps shown in FIG. 6 and the elements shown in FIG. 2, and further description is omitted here for brevity. The step S601 is executed by the determining circuit 110, the step S602 is executed by the first computing unit 230, and the step S603 is executed by the decision unit 222.

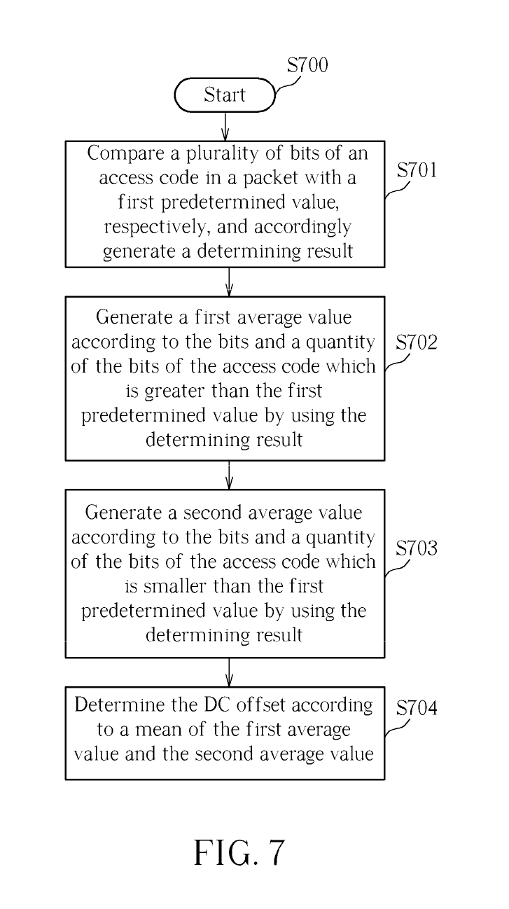

Please refer to FIG. 7. FIG. 7 is a flowchart illustrating a DC offset estimation method according to another exemplary embodiment of the present disclosure.

Step S700: Start.

Step S701: Compare a plurality of bits of an access code in a packet with a first predetermined value, respectively, and accordingly generate a determining result.

Step S702: Generate a first average value according to a value and a quantity of the bits of the access code which is greater than the first predetermined value by using the determining result.

Step S703: Generate a second average value according to a value and a quantity of the bits of the access code which is smaller than the first predetermined value by using the determining result.

Step S704: Determine the DC offset according to a mean of the first average value and the second average value.

Those skilled in the art can readily understand how each element operates by combining the steps shown in FIG. 7 and the elements shown in FIG. 3, and further description is omitted here for brevity. The step S701 is executed by the determining circuit 110, the step S702 is executed by the first computing unit 230, and the step S703 is executed by the second computing unit 340, and the step S704 is executed by the decision unit 322.

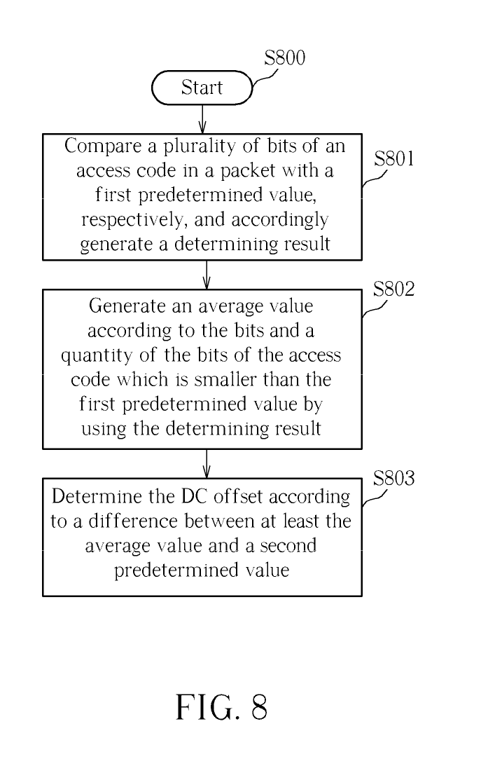

Please refer to FIG. 8. FIG. 8 is a flowchart illustrating a DC offset estimation method according to still another exemplary embodiment of the present disclosure.

Step S800: Start.

Step S801: Compare a plurality of bits of an access code in a packet with a first predetermined value, respectively, and accordingly generate a determining result.

Step S802: Generate an average value according to a value and a quantity of the bits of the access code which is smaller than the first predetermined value by using the determining result.

Step S803: Determine the DC offset according to a difference between at least the average value and a second predetermined value.

Those skilled in the art can readily understand how each element operates by combining the steps shown in FIG. 8 and the elements shown in FIG. 4, and further description is omitted here for brevity. The step S801 is executed by the determining circuit 110, the step S802 is executed by the first computing unit 430, and the step S803 is executed by the decision unit 422.

The abovementioned embodiments are presented merely to illustrate practicable designs of the present disclosure, and should not be considered to be limitations of the scope of the present disclosure. In summary, a DC offset estimation device and a DC offset estimation method are provided in the present disclosure. By using a plurality of bits of the access code, the DC offset can be accurately and quickly estimated in order to solve the frequency offset effect and problem. Therefore, the data of the access code in the packet can be conveniently computed.

Those skilled in the art will readily observe that numerous modifications and alterations of the device and method may be made while retaining the teachings of the invention.

What is claimed is:

1. A DC offset estimation device, comprising:
a determining circuit, for comparing a plurality of bits of an access code in a packet with a first predetermined value, respectively, and accordingly generating a determining result; and
an estimation circuit, coupled to the determining circuit, for estimating a DC offset according to the determining result.

2. The DC offset estimation device according to claim 1, wherein the estimation circuit comprises:
a first computing unit, coupled to the determining circuit, for generating a first average value according to a value and a quantity of the bits of the access code which is greater than the first predetermined value by using the determining result; and
a decision unit, coupled to the first computing unit, for estimating the DC offset according to at least the first average value.

3. The DC offset estimation device according to claim 2, wherein the decision unit is arranged for determining the DC offset according to a difference between the first average value and a second predetermined value.

4. The DC offset estimation device according to claim 2, wherein the first computing unit comprises:
a first quantity accumulation unit, for accumulating the quantity of the bits of the access code which is greater than the first predetermined value by using the determining result, and accordingly generating a first quantity accumulated value;
a first quantity comparing unit, for comparing the first quantity accumulated value with a first threshold; and
a first average unit, for calculating the first average value when the first quantity accumulated value is greater than the first threshold.

5. The DC offset estimation device according to claim 2, wherein the estimation circuit further comprises:
a second computing unit, coupled to the determining circuit and the decision unit, for generating a second average value according to a value and a quantity of the bits of the access code which is smaller than the first predetermined value by using the determining result, wherein the decision unit is arranged for estimating the DC offset according to the first average value and the second average value.

6. The DC offset estimation device according to claim 5, wherein the decision unit is arranged for determining the DC offset according to a mean of the first average value and the second average value.

7. The DC offset estimation device according to claim 5, wherein the second computing unit comprises:
a second quantity accumulation unit, for accumulating the quantity of the bits of the access code which is smaller than the first predetermined value by using the determining result, and accordingly generating a second quantity accumulated value;
a second quantity comparing unit, for comparing the second quantity accumulated value with a second threshold; and
a second average unit, for calculating the second average value when the second quantity accumulated value is greater than the second threshold.

8. The DC offset estimation device according to claim 1, wherein the estimation circuit comprises:
a computing unit, coupled to the determining circuit, for generating an average value according to a value and a quantity of the bits of the access code which is smaller than the first predetermined value by using the determining result; and
a decision unit, coupled to the computing unit, for estimating the DC offset according to the average value.

9. A DC offset estimation method, comprising:
comparing a plurality of bits of an access code in a packet with a first predetermined value, respectively, and accordingly generating a determining result; and
estimating a DC offset according to the determining result.

10. The DC offset estimation method according to claim 9, wherein the step of estimating the DC offset according to the determining result comprises:
generating a first average value according to a value and a quantity of the bits of the access code which is greater than the first predetermined value by using the determining result; and
estimating the DC offset according to at least the first average value.

11. The DC offset estimation method according to claim 10, wherein the step of estimating the DC offset according to at least the first average value comprises:
determining the DC offset according to a difference between the first average value and a second predetermined value.

12. The DC offset estimation method according to claim 10, wherein the step of generating the first average value according to the value and the quantity of the bits of the access code which is greater than the first predetermined value by using the determining result comprises:
accumulating the quantity of the bits of the access code which is greater than the first predetermined value by using the determining result, and accordingly generating a first quantity accumulated value;
comparing the first quantity accumulated value with a first threshold; and
calculating the first average value when the first quantity accumulated value is greater than the first threshold.

13. The DC offset estimation method according to claim 10, wherein the step of estimating the DC offset according to the determining result further comprises:
generating a second average value according to a value and a quantity of the bits of the access code which is smaller than the first predetermined value by using the determining result; and
the step of estimating the DC offset according to at least the first average value comprises:
estimating the DC offset according to the first average value and the second average value.

14. The DC offset estimation method according to claim 13, wherein the step of estimating the DC offset according to the first average value and the second average value comprises:
determining the DC offset according to a mean of the first average value and the second average value.

15. The DC offset estimation method according to claim 13, wherein the step of generating the second average value according to the value and the quantity of the bits of the access code which is smaller than the first predetermined value by using the determining result comprises:
accumulating the quantity of the bits of the access code which is smaller than the first predetermined value by using the determining result, and accordingly generating a second quantity accumulated value;
comparing the second quantity accumulated value with a second threshold; and
calculating the second average value when the second quantity accumulated value is greater than the second threshold.

16. The DC offset estimation method according to claim 9, wherein the step of estimating the DC offset according to the determining result comprises:
generating an average value according to a value and a quantity of the bits of the access code which is smaller than the first predetermined value by using the determining result; and
estimating the DC offset according to the average value.
